(19) United States
(12) Patent Application Publication
(10) Pub. No.: US 2003/0088565 A1
(43) Pub. Date: May 8, 2003

(54) Method and system for mining large data sets

(75) Inventors: Thomas James Walter, Issaquah, WA (US); Stephen P. Kaluzny, Seattle, WA (US); Douglas R. Martin, Seattle, WA (US); Charles B. Roosen, Seattle, WA (US); Michael J. Sannella, Seattle, WA (US)

Correspondence Address: SEED INTELLECTUAL PROPERTY LAW GROUP PLLC, 701 FIFTH AVE, SUITE 6300, SEATTLE, WA, 98104-7092, US

(73) Assignee: Insightful Corporation, Seattle, WA

(21) Appl. No.: 10/272,504

(22) Filed: Oct. 15, 2002

Related U.S. Application Data
(60) Provisional application No. 60/329,827, filed on Oct. 15, 2001.

(51) Int. Cl. G06F 7/00

(52) U.S. Cl. 707/6

(57) ABSTRACT

Methods and systems for mining large data sets using block model averaging techniques are provided. Example embodiments provide a Block Model Averaging System (“BMAS”), which enables users to build/train, test, deploy, and maintain predictive statistical models that can be used to gain knowledge from both static and dynamic data. In one embodiment, the BMAS incrementally builds predictive models from portions (blocks) of input data using block model averaging techniques, determines a voting population of the predictive models to use as components of an ensemble model, generates an ensemble model with these determined components, and deploys the generated ensemble model to input data to derive answers. One technique for determining the voting population is correctness; another is diversity of response. When the BMA ensemble model is deployed, it incorporates a voting protocol, appropriate to the component predictive models, to derive a single response from the outputs of the component predictive models. In one embodiment, the BMAS comprises an ensemble generator, one or more predictive model generators, and a voting and model data repository. These components cooperate to generate predictive models using BMA and to combine appropriate subsets of these models to generate an ensemble model.

### BACKGROUND OF THE INVENTION

1. Field of the Invention

The present invention relates to methods and systems for data mining of large sets of data and, in particular, to methods and systems for determining information and providing predictive tools for arbitrarily large data sets and for streaming data.

### BACKGROUND INFORMATION

Effective discovery of knowledge from masses of data is an ever-growing concern in the machine learning community. Companies and other organizations, which have begun to incorporate statistical techniques into marketing, customer support, and manufacturing processes are realizing the limitations of some of these approaches on very large data sets, such as found in customer relationship management (CRM), enterprise resource planning (ERP), and supply chain management (SCM) databases. As a data set gets extremely large, current methods for building statistical models that can be used to predict characteristics and trends from the entirety of the data become difficult to use, if not inoperable, for three reasons. First, as the number of records (e.g., rows) in the data increases, the time required by such model building methods increases more than linearly and, at some point, takes more than a practical amount of time to perform. Second, these methods require the data set to be totally in memory, and, as the data set grows, the data set may become too large to reside in memory at one time, thus rendering the method unusable. Third, traditional methods that look at the entirety of the data assume either a static nature of the data or re-compute the entire model (or models) when the data changes. Such methods are therefore unsuitable for modeling and predicting dynamically changing data or streaming data, such as stock prices or weather measurements. Example traditional methods include decision trees, which are discussed in Breiman, L., et. al., “Classification and Regression Trees,” Wadsworth, 1983, and Hastie, T., et. al., “The Elements of Statistical Learning,” Springer, 2001, which are incorporated herein by reference in their entirety.

In response to these challenges, methods for building predictive statistical models from samples of the input (or test) data, as opposed to the whole of the data, have been developed. These methods take some number of random samples from the input data, sometimes with the ability to replace each input sample with another input sample to derive a next model, and use these samples to derive a population of models, which may be used as an “ensemble model” to derive predictive answers. An ensemble model generally refers to a set of component models that cooperate to achieve a response (output) typically through a “voting” procedure. One such method, known as “bagging” or “bootstrap aggregation” is well-known in the art and is described, for example, in Friedman, J. H. and Hall, P., “On Bagging and Nonlinear Estimation,” Stanford University, May, 1999 and L. Breiman, “Bagging Predictors,” UC Berkeley, Department of Statistics, Technical Report 421, 1994, which are incorporated herein by reference in their entirety. Because these sampling methods use a portion of the data set and not the whole data set to train the models, sometimes important characteristics are missed and at other times sample data are repeated by the random sampling techniques used. These disadvantages may leave the entire data modeling process open to challenge with respect to the statistical techniques used. Thus, typically, a statistician (or other such user of these models) accrues greater advantage by avoiding these challenges altogether and instead increasing confidence in the model building process by using the entire data set when building (training) models.

### BRIEF SUMMARY OF THE INVENTION

Embodiments of the present invention provide enhanced computer- and network-based methods and systems for building, using, and managing predictive models as part of a machine learning process. Example embodiments provide a Block Model Averaging System (“BMAS”), which enables users to build/train, test, and maintain predictive statistical models that can be used to gain knowledge about data, including very large amounts of data and data that is dynamic, such as streaming data. Block model averaging (“BMA”) is a process by which sequential or incremental blocks of data are progressively read from an input source to produce a set of statistical models that cooperate in an ensemble model to predict knowledge about input data (e.g., test data, new data, or other data). The BMA process can be used to create traditional classification models, such as: classification trees, classification neural networks, logistic regression, and Naïve Bayes; as well as traditional regression models, such as: regression trees, regression neural networks, and linear regression.

In one example embodiment, the BMAS comprises one or more functional components/modules that work together to build individual BMA predictive models and an ensemble model that incorporates some or all of these individual BMA predictive models. For example, a BMAS may comprise an ensemble generator, predictive model generator(s), and a voting and model data repository. The predictor model generator(s) build individual predictive models for each block of data. The ensemble generator generates an ensemble model that contains component predictive models and a voting protocol. Ensemble models may be created for static data or may be created for more dynamic data, for example, streaming data. The voting and model data repository contains configuration data that is needed to build the individual predictive models and to generate an ensemble model that incorporates some set of these predictive BMA models as components.

According to one approach, the ensemble generator produces predictive models that are nodes in a pipeline architecture. In some embodiments, the nodes in the pipeline respond to buffered input so that the BMA ensemble need not read in the data more than once.

The BMA ensemble generator may select component predictive models using a voting population filter. Example filters include finding the most correct component models and finding models that yield the greatest diversity of response. Generated ensemble models may be adapted to adjust for new input data, for example data streams.

Voting protocols included by example BMA ensembles include, for example, straight majority voting, with or without tie-breaking rules; averaging; and weighted averaging. In one embodiment, the percentage that a classification value will occur is used as a weighted average for voting purposes.

### BRIEF DESCRIPTION OF THE DRAWINGS

FIG. 1 is a block diagram of an example ensemble model built by an example Block Model Averaging System.

FIG. 2 is an example block diagram of an overview of an example data mining process.

FIG. 3 is an example block diagram of a pipeline data mining architecture for use with block model averaging techniques.

FIG. 4 is a block diagram of an example block model averaging pipeline used to build a set of predictive models for an input data set.

FIG. 5 is a block diagram of an example process for generating an ensemble model from the predictive models built using block model averaging.

FIG. 6 is an example block diagram of components of an example Block Model Averaging System.

FIG. 7 is an example display screen of a data mining workflow that incorporates BMA ensemble models as modules in a data mining pipeline.

FIG. 8 is an example display screen of an interface for instructing a model generator node to generate a BMA ensemble model.

FIG. 9 is an example display screen of an interface for setting characteristics of a BMA ensemble model.

FIG. 10 is an example display screen for viewing one of the component predictive models of a generated BMA ensemble model.

FIG. 11 is an example display screen for viewing a second one of the component predictive models of the generated BMA ensemble model.

FIG. 12 is an example block diagram of a general purpose computer system for practicing embodiments of a Block Model Averaging System.

FIG. 13 is an example block diagram of a process for building a BMA ensemble from static data.

FIG. 14 is an example block diagram of a process for building a BMA ensemble from dynamic data.

FIG. 15 is an example flow diagram of an example ensemble generation routine provided by an ensemble generator for generating and/or adapting a BMA ensemble model.

FIG. 16 is an example block diagram of data flow through the components of a BMA ensemble model when deployed to predict a response output.

FIG. 17 is an example flow diagram of an example routine provided by a BMA ensemble for processing input data to achieve a predictive response.

### DETAILED DESCRIPTION OF THE INVENTION

Embodiments of the present invention provide enhanced computer- and network-based methods and systems for building, using, and managing predictive models as part of a machine learning process. Example embodiments provide a Block Model Averaging System (“BMAS”), which enables users such as researchers, knowledge engineers, marketing and manufacturing personnel, etc. to build/train, test, and maintain predictive statistical models that can be used to gain knowledge about data, especially very large amounts of data and data that is dynamic, such as streaming data. Block model averaging (“BMA”) is a process by which sequential or incremental blocks of data are progressively read from an input source to produce a set of statistical models that cooperate in an ensemble model to predict knowledge about input data (e.g., test data, new data, or other data). The BMA process can be used to create traditional classification models, such as: classification trees, classification neural networks, logistic regression, and Naïve Bayes; as well as traditional regression models, such as: regression trees, regression neural networks, and linear regression. One skilled in the art will recognize, however, that the techniques of BMA may be useful to create a variety of other statistical models as well, including those that are not yet known, especially those models that can employ incremental techniques to discover information about data. BMA is superior to a “bagging” approach in that the entire input data is used to build the predictive models based upon the data (not just samples of the input data), and thus BMA is less prone to criticism from statisticians. Also, because BMA can be used incrementally to process a very large data set, the model building process time doesn't continue to increase with the size of data. In addition, as will be described in further detail below, the BMA process is compatible with streaming and other types of dynamic data, and BMA models can adapt to newly received data as it is processed.

A typical BMAS incrementally builds (discovers) the predictive models using block model averaging techniques, determines a voting population of the predictive models to use as components in an ensemble model, generates a BMA ensemble model with these determined components, and then applies the generated BMA ensemble model to input data to derive answers. When deployed, the BMA ensemble model incorporates a voting protocol, which may vary with the type of model, to derive a response output from the (intermediate) outputs of the component predictive models. The voting protocol typically specifies how to combine the various outputs from the component predictive models, including techniques for weighting the various outputs if appropriate to achieve a response output.

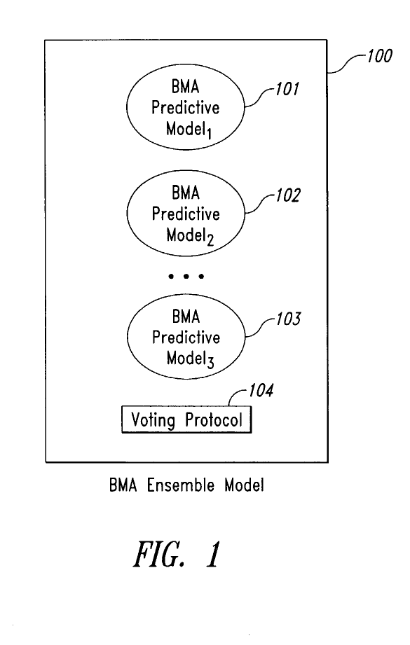

FIG. 1 is a block diagram of an example ensemble model built by an example Block Model Averaging System. The BMA ensemble model 100 comprises one or more component BMA predictive models 101-103 and a voting protocol 107. As explained in further detail below, the predictive models 101-103 are built preferably using a pipelined block model averaging process and are built appropriate to the model type desired. Although not shown here, one skilled in the art can recognize that additional embodiments are possible that combine models of different types (a heterogeneous ensemble model), as long as the voting protocol 107 is implemented to arbitrate properly between them to achieve a unified result.

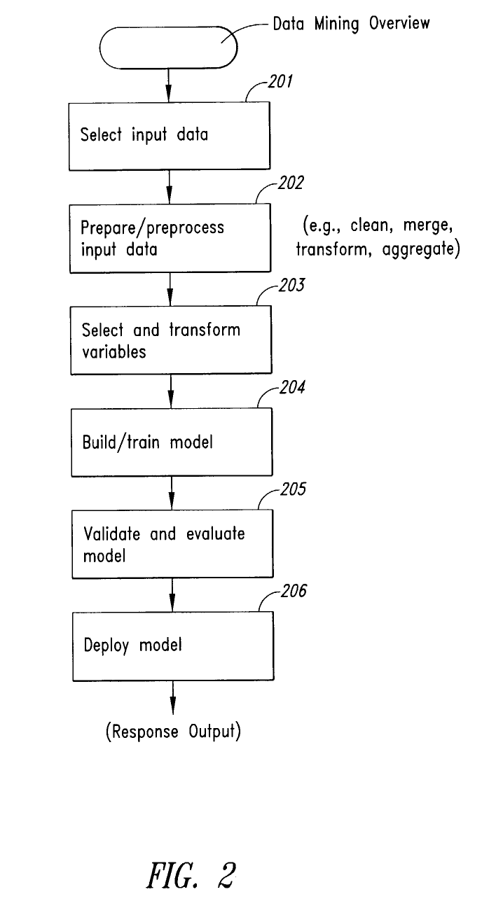

In a typical machine learning environment, the BMAS operates to generate and maintain predictive models as a step in an overall data mining process. FIG. 2 is an example block diagram of an overview of an example data mining process. Data mining typically comprises a series of steps that are performed by a computer system and driven by the needs of a user, for example, a researcher. In step 201, the user selects what input data is to be used to build (train) the predictive model(s). In step 202, the user prepares and/or preprocesses the input data, for example, to clean, merge, transform, or aggregate portions of the data. In step 203, the user designates which independent variables are to be used to determine which dependent (predicted) variables and transforms them to alternative expressions or values if needed. In step 204, the data mining system automatically builds a model of the modified input data that predicts values for the designated dependent variables as determined by the designated independent variables based upon the preferences specified by the user in steps 201-203. In step 205, the user can invoke different tools to validate and evaluate the model. For example, if more than one type of model is built, the user may wish to see which model appears to be more accurate in handling the data (for example, by checking for few misclassifications in the case of a classification tree model). In step 206, a predictor model is deployed, for example, to perform predictive analysis of new input data. The BMA system is typically invoked as part of the model building process (step 204) and when the predictive model is deployed for use (step 206). It may also be used in the testing and validation processes.

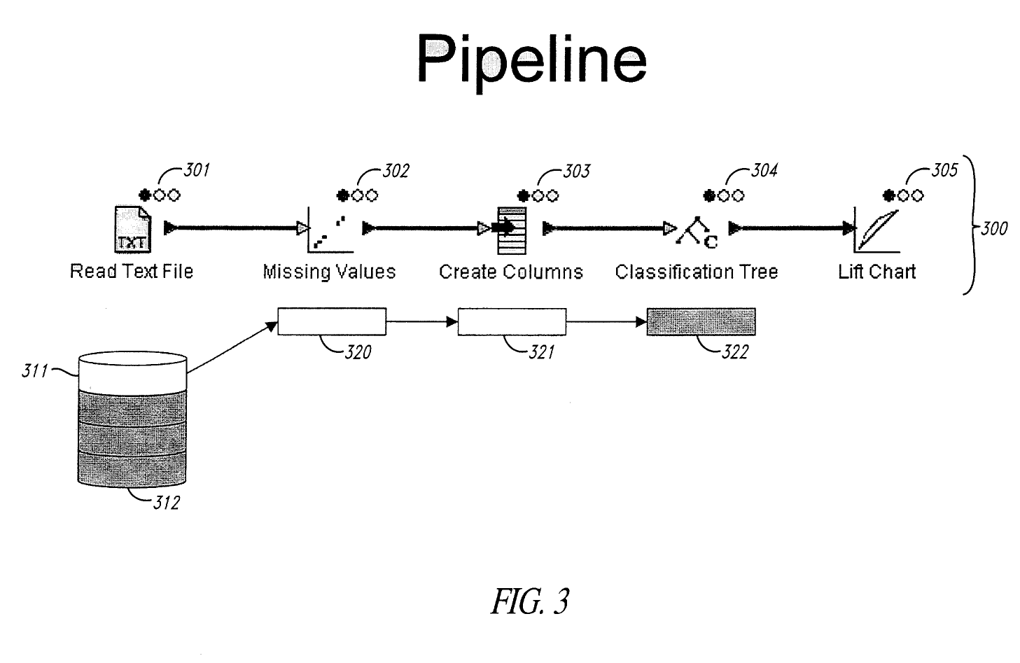

Because block model averaging processes sequential blocks of input data to produce a set of statistical models, use of a pipeline architecture for implementing data mining complements the BMA model building techniques. FIG. 3 is an example block diagram of a pipeline data mining architecture for use with block model averaging techniques. Each component (also referred to as a “module” or “node”) in pipeline 300 implements one or more of the steps involved in the overall data mining process discussed with reference to FIG. 2. The modules shown are merely examples of functionality incorporated into an example embodiment. Module 301 supports the reading of input data in user definable blocks (“chunks”) of data, for example, data portion 311, from a designated file, for example, file 310. Once the data portion 311 is read in, it is forwarded (e.g., in data buffer 320) to the missing values module 302, which is part of the data cleaning process and which enables the user to define how missing values in the data should be supplied. Data at each stage may be stored, for example, in a separate buffer so that the data can be accessed by the next module in the pipeline as it is made available and ready for the next module to process. The cleaned data (e.g., in data buffer 321) can then be further manipulated, for example, through module 303, to add “columns” to represent information the researcher is looking to discover. For example, a column may be added for a value (for a dependent variable) that is to be predicted from known other values (from independent variables). Once the data portion 311 has been preprocessed and variables selected for the modeling process, the preprocessed data (e.g., in data buffer 322) is then forwarded to a model building module 304 to build/train a model based upon the processed block of data. Module 305 is an example validation module that is used to assess the effectiveness of the model that was built by module 304. In an example embodiment, additional modules, user and system defined, can be added to the pipeline by appropriately connecting their input and output connectors to other modules. Use of a pipeline architecture for data mining further allows the BMA process to be implemented by parallel processing techniques and by distributed processing techniques. Insightful Miner 2.0 Desktop Edition, available from Insightful Corp., is an example embodiment of this pipeline architecture as used with a BMA system.

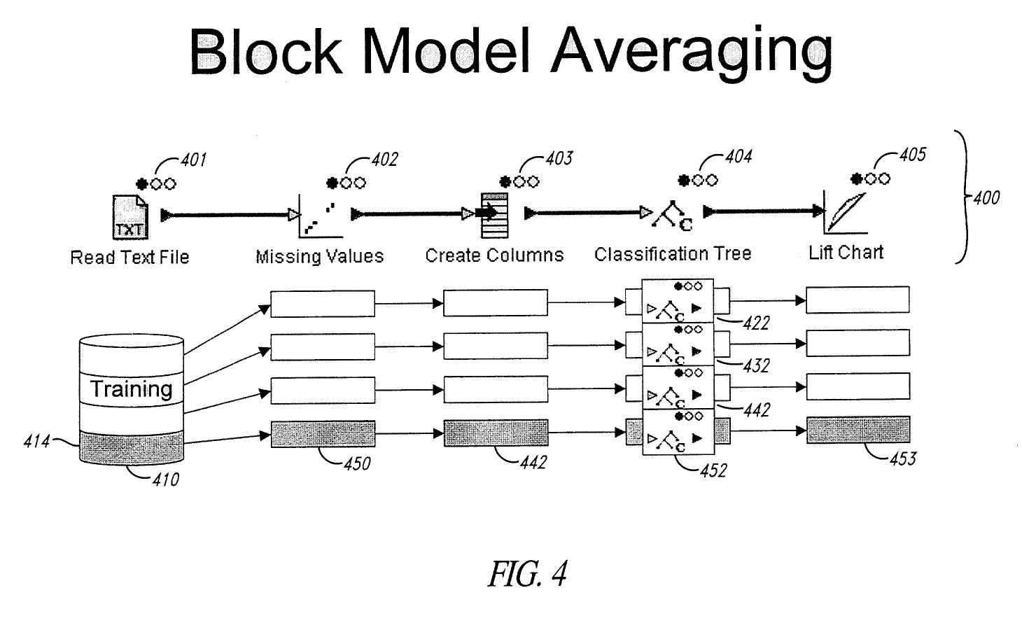

FIG. 4 is a block diagram of an example block model averaging pipeline used to build a set of predictive models for an input data set. FIG. 4 illustrates how a pipeline architecture approach can be used with block model averaging to incrementally produce a separate predictive model for each block of data. Although shown using classification trees as the model type, one skilled in the art will appreciate that this same pipeline process can work with other model types and is independent of the type of model being used in the system. In FIG. 4, pipeline 400 comprises modules 401-405, which are similar to their counterparts described with reference to FIG. 3, except that the classification tree model generator component 404 is implemented to automatically build a separate predictive model (e.g., classification tree models 422, 432, 442, and 452) for each block of data 410 that is processed by the pipeline.

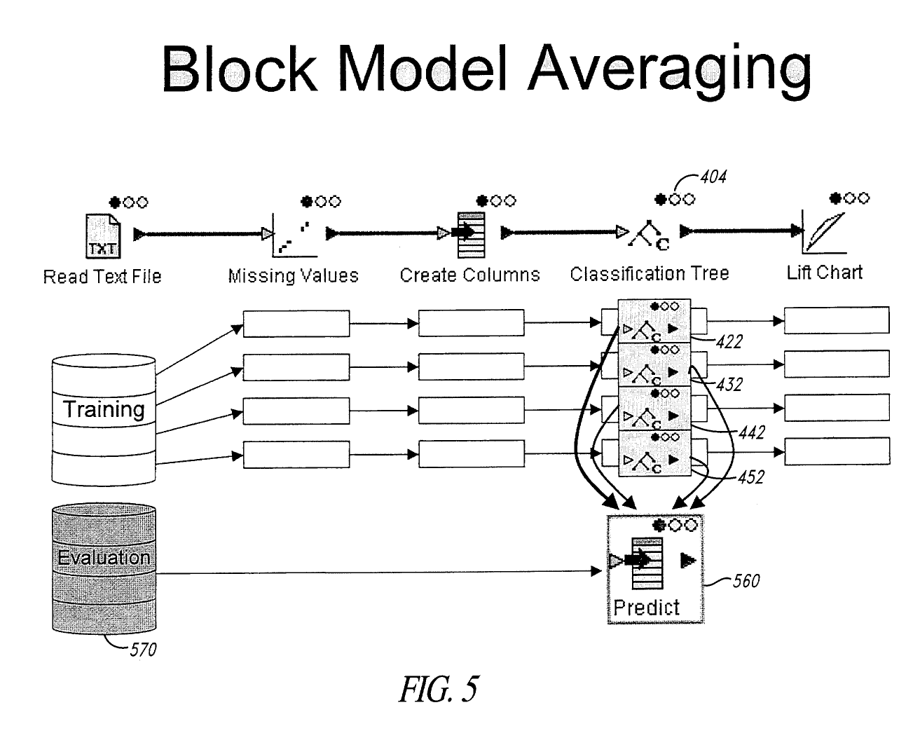

FIG. 5 is a block diagram of an example process for generating an ensemble model from the predictive models built using block model averaging. In FIG. 5, when a request is received to build a predictor module from the model building module 404, for example by invoking a “build predictor” action on module 404, then a predictor module 560 is generated that includes as components one or more of the predictive models 422, 432, 442, and 452. The predictor module 560 (a BMA ensemble model) can then be tested using evaluation data 570.

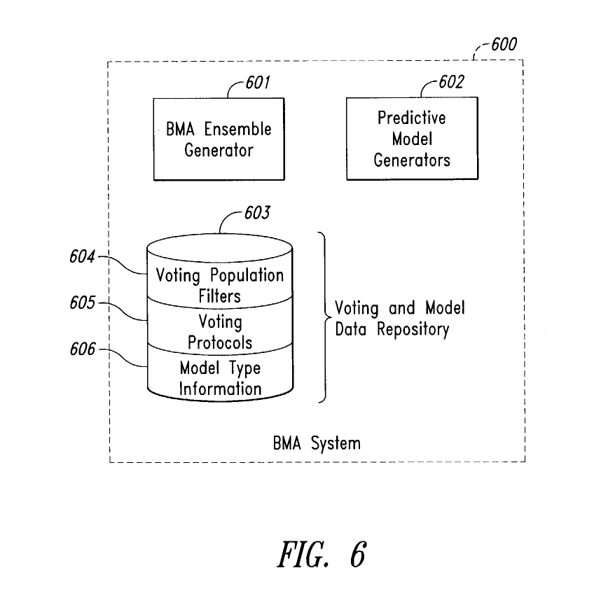

FIG. 6 is an example block diagram of components of an example Block Model Averaging System. In one embodiment, the BMAS comprises one or more functional components/modules that work together to build individual BMA predictive models and an ensemble model that incorporates some or all of these individual BMA predictive models. One skilled in the art will recognize that these components may be implemented in software or hardware or a combination of both.

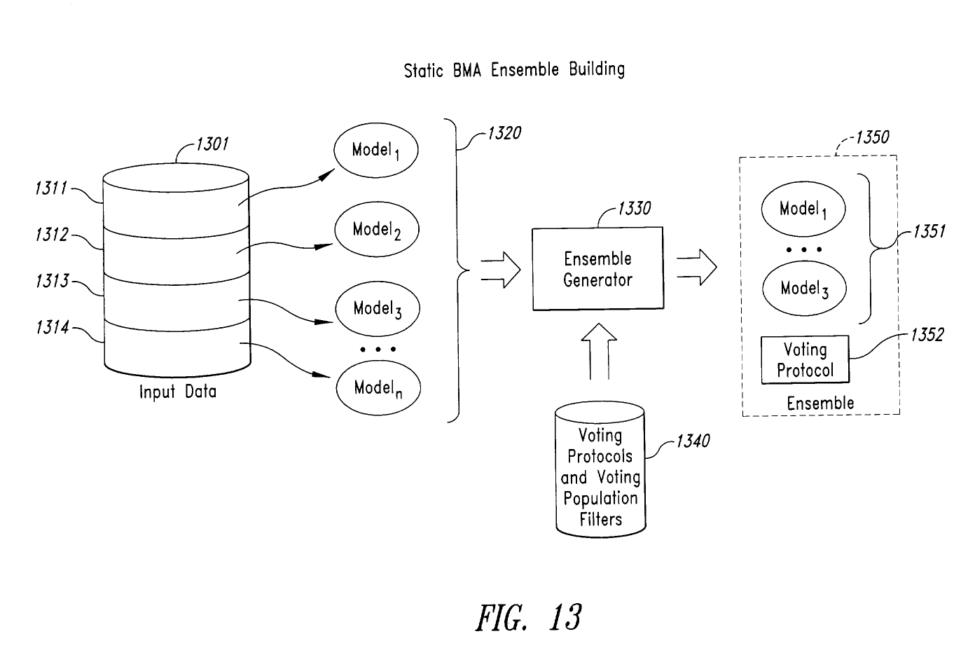

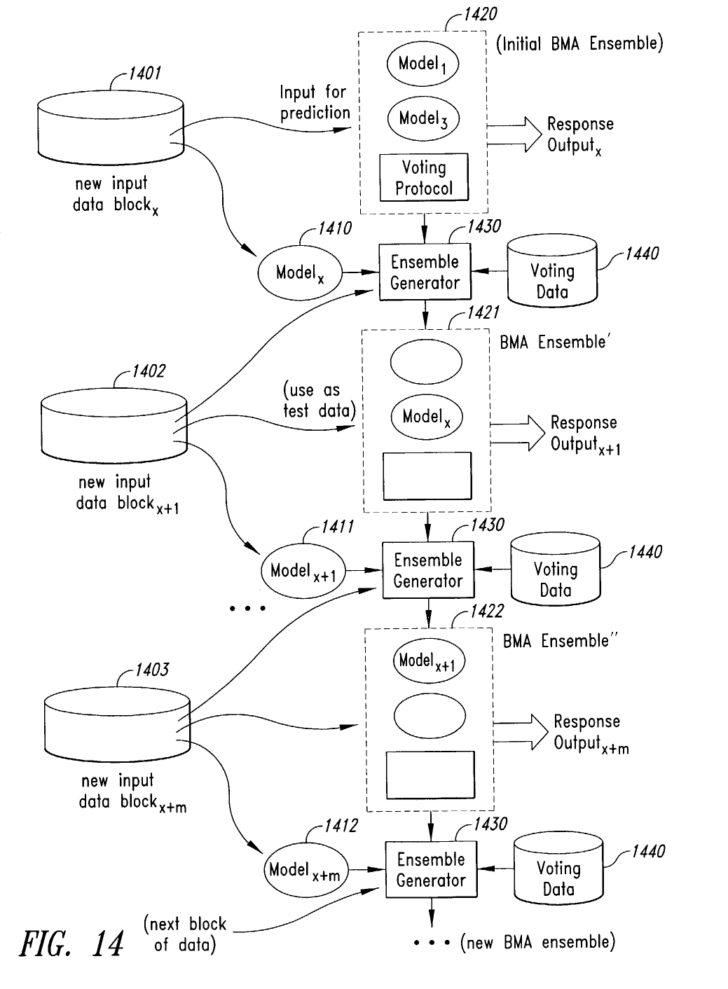

In FIG. 6, BMAS 600 comprises an ensemble generator 601, predictive model generator(s) 602, and a voting and model data repository 603. The predictive model generator(s) 602 build predictive models for a particular model type and potentially comprise one or more generators for each type. For example, a separate generator may exist for regression models and for classification models, or further, a separate generator may exist for each subtype of classification model. The ensemble generator 601 generates an ensemble model that contains component predictive models and a voting protocol. Ensemble models may be created for static data, as discussed further with reference to FIG. 13, or may be created for more dynamic data, for example, streaming data, as discussed further with reference to FIG. 14.

The voting and model data repository 603 contains configuration data that is needed to build the individual predictive models and to generate an ensemble model that combines some set of these predictive models. The data repository 603 represents information that is stored somewhere in the system, and does not necessarily imply that the storage is located in memory, in a database, or in a file. The voting and model repository 603 contains voting population filters 604, voting protocols 605, and model type information 606. The model type information 606 stores data needed to construct an individual predictive model for a particular model type. The voting population filters 604 contain the procedures (e.g., business rules) that determine, for a particular model type, which individual models to include as components in the overall ensemble model. In some embodiments, a voting population is determined by which component models generate the most accurate answers. In other embodiments, a voting population is determined by which components yield the most “diverse” answers. One skilled in the art will recognize that other rules and filters for determining the voting population could be incorporated into the BMA ensemble generating techniques as described. The voting protocols 605 are the rules used by an ensemble model to combine the output from each of its component models into a single predictive response. (Note that a single response may contain a plurality of values.) Although the techniques of block model averaging and the BMAS are generally applicable to any type of decision model (that implements supervised or unsupervised machine learning), the phrase “model” (“predictive model” or “decision model”) is used generally to imply any type of model (e.g., classification, regression, and clustering models, classification trees, regression trees, decision trees, neural networks, additive models, linear and logical regression techniques, etc.) that can be used to create an ensemble of sub-models (a voting population) whose responses can be combined to look like and act as a response of one model. In addition, one skilled in the art will recognize that ensembles can be formed not just from homogeneous voting populations, but from heterogeneous ones (i.e. different model types) as well. Also, although the examples described herein often refer to a marketer desiring knowledge from a CRM database, one skilled in the art will recognize that the techniques of the present invention can also be used by other people researching predictive information from input data. In addition, the concepts and inventions described are applicable to other input data, including other types of textual data (both structured and unstructured) and data other than textual data, such as graphical, audio, and video data, as long as statistical models that work incrementally or in a sampling fashion are available to process such input data. Essentially, the concepts and inventions described are applicable to any stream of electronically coded data with signal and noise where the objective is to learn/predict one or more response component(s) of the signal from one or more predictor component(s) while limiting the impact of the noise. Also, although certain terms are used primarily herein, one skilled in the art will recognize that other terms could be used interchangeably to yield equivalent embodiments and examples. For example, it is well-known that equivalent terms in the statistics field and in other similar fields could be substituted for such terms as “input variables, output variables,” etc. Specifically, the term “input variable” can be used interchangeably with “predictors,” “independent variables,” etc. Likewise, the term “output variable,” “value,” or just “output” can be used interchangeably with the terms “responses,” “dependent variables,” etc. In addition, terms may have alternate spellings which may or may not be explicitly mentioned, and one skilled in the art will recognize that all such variations of terms are intended to be included.

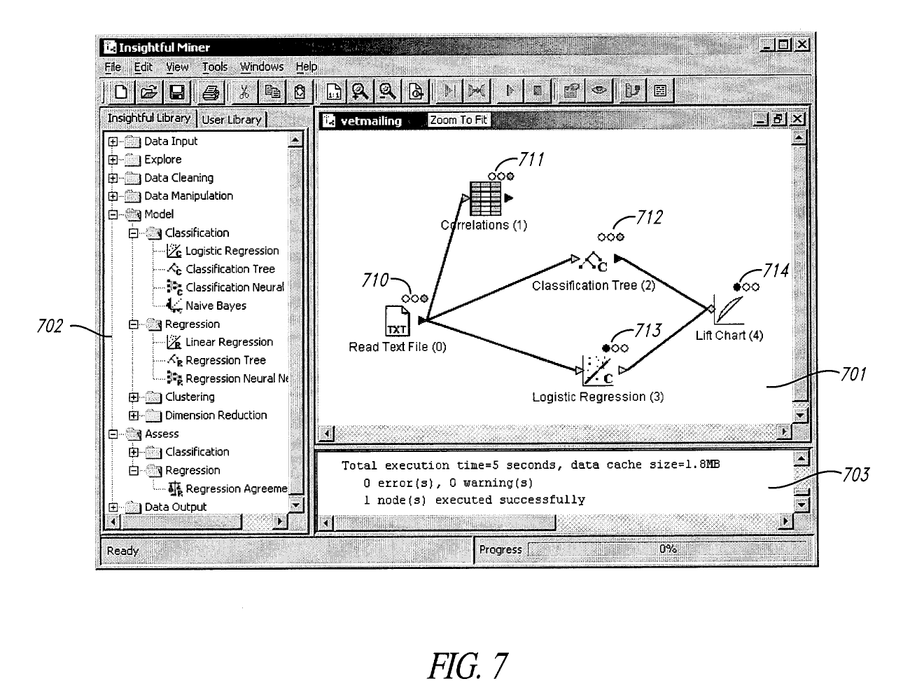

FIGS. 7-11 are example display screens of an example user interface for defining and managing a classification based BMA ensemble model that incorporates techniques of the present invention. FIG. 7 is an example display screen of a data mining workflow that incorporates BMA ensemble models as modules (nodes) in a data mining pipeline. In FIG. 7, workflow window 701 shows a pipeline of created nodes (modules) 710-714 that have been connected together to incrementally process input data from a file named “vetmailing.” Window 702 contains a list of possible modules for inclusion in the pipeline. The Classification Tree node 712 and the Logistic Regression node 713 can be set up to produce BMA ensemble models as described herein. Window 703 is a status and message window that informs the user of progress when individual nodes are executed. The interface illustrated allows a user to execute portions of the pipeline (one or more nodes as specified) without running the entire pipeline, thus enabling a user to focus on, correct, or adjust portions of the modeling process incrementally.

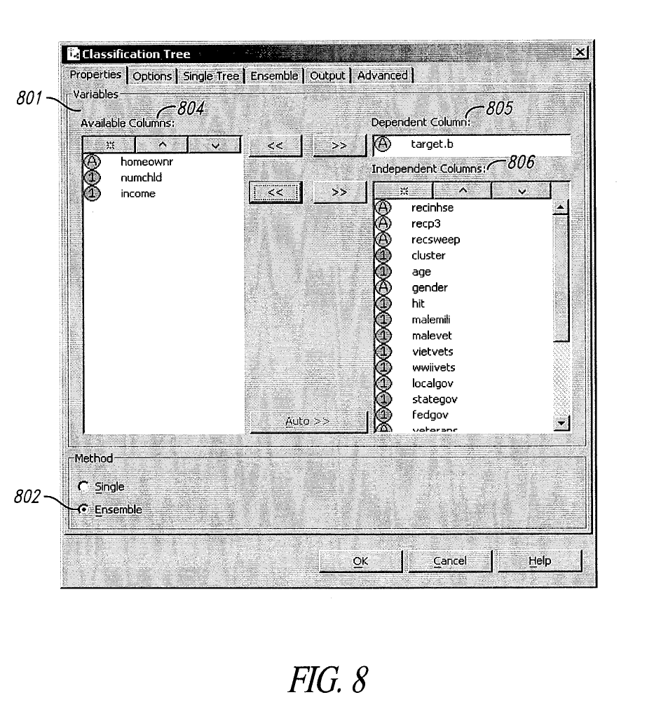

FIG. 8 is an example display screen of an interface for instructing a model generator node to generate a BMA ensemble model. Properties dialog window 801 presents an interface for specifying which variables (available columns 804) should be used as independent variables (independent columns 806) to predict dependent variable (dependent column 805). The dependent column 805 represents, for each row of data, the value that is being predicted using the statistical model. Button 802 specifies that the model to be generated is a (BMA) ensemble model, which functionally resembles ensemble model 100 in FIG. 1.

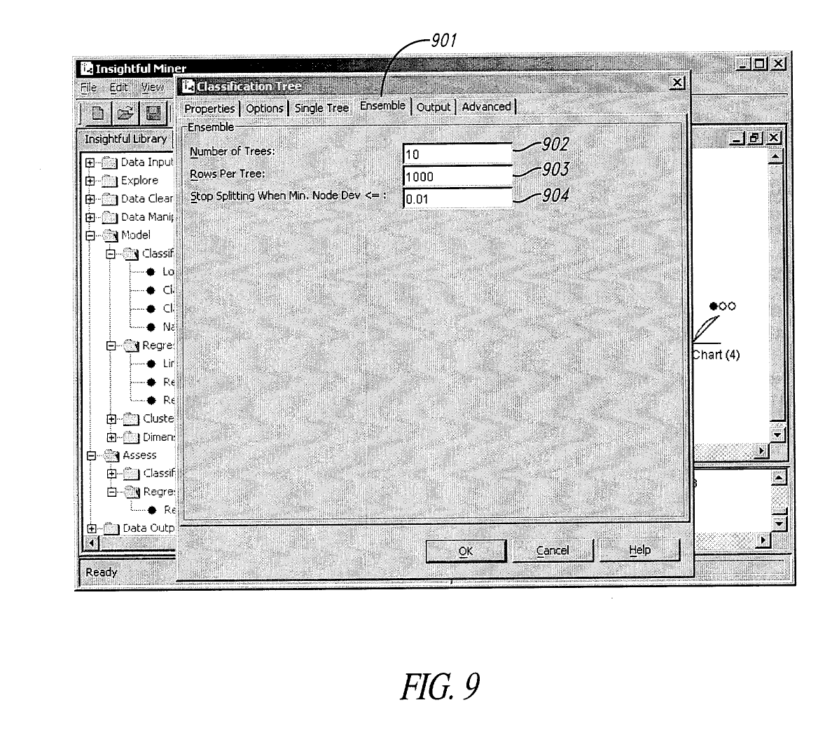

FIG. 9 is an example display screen of an interface for setting characteristics of a BMA ensemble model. Example ensemble settings dialog window 901 contains three fields for configuring the ensemble model to be generated. Field 902 specifies the number of trees (models) to be included as component predictive models of the ensemble to be generated (i.e., the size of the ensemble model). Field 903 specifies the number of rows (data block size) to be processed as input to create an individual predictive model. Field 904 specifies (in the case of a classification tree model) how deep the tree should be generated. Keeping a tree from splitting to process every row in the input prevents training noise into the model. In the particular example shown, the “stop splitting” field specifies that nodes should not be further split when the deviance measurement between them is less than or equal to 0.01. One skilled in the art will recognize that other techniques exist for determining and indicating when a tree should stop growing deeper or wider or when it should be pruned. Current experimentation with BMA ensemble modeling techniques has shown that, counter to intuition gained from single classification trees, a BMA ensemble of classification trees may perform better when some amount of noise is trained into the tree.

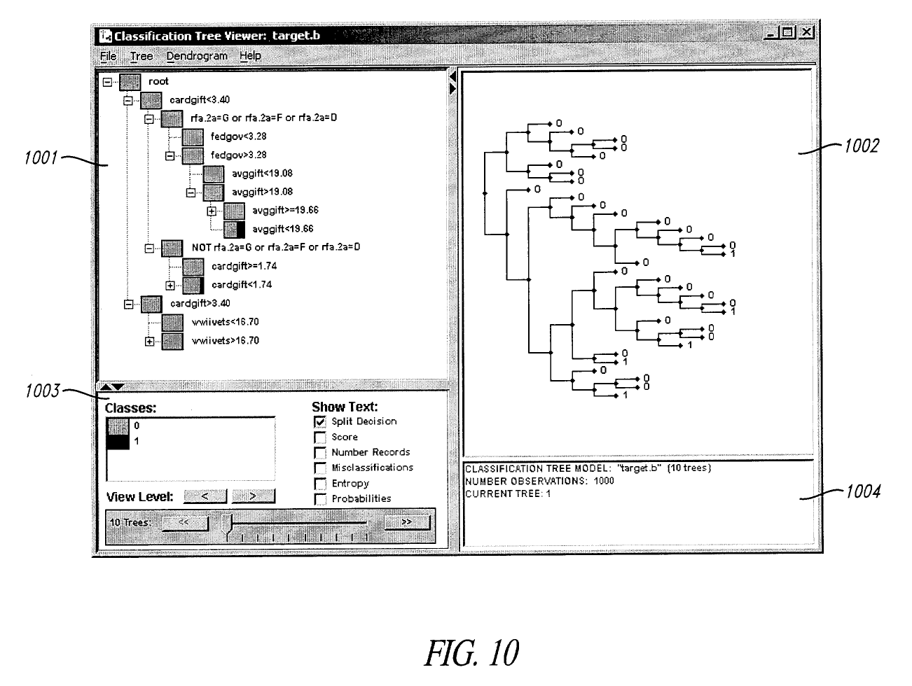

FIG. 10 is an example display screen for viewing one of the component predictive models of a generated BMA ensemble model. The classification tree (predictive model) shown in model window 1002 is tree number “1” of the 10 trees that comprise the ensemble model of the current example. Tree window 1001 contains a description of each of the nodes in the tree shown in model window 1002 and is labeled according to the selections designated by the checkboxes in descriptive window 1003. Viewing the tree in this manner allows a user to gain understanding of the degree to which the model is modeling noise, how well the model is performing (how many misclassifications are present), etc. Based upon this information, the user can modify the ensemble characteristics as described in FIG. 9 to generate a different width/breadth of tree. In addition, attributes such as misclassifications are stored and used by the ensemble generator to determine which component predictive models to keep and which to replace when adapting the ensemble model to new data. Adaptive modeling is described below with reference to FIG. 14.

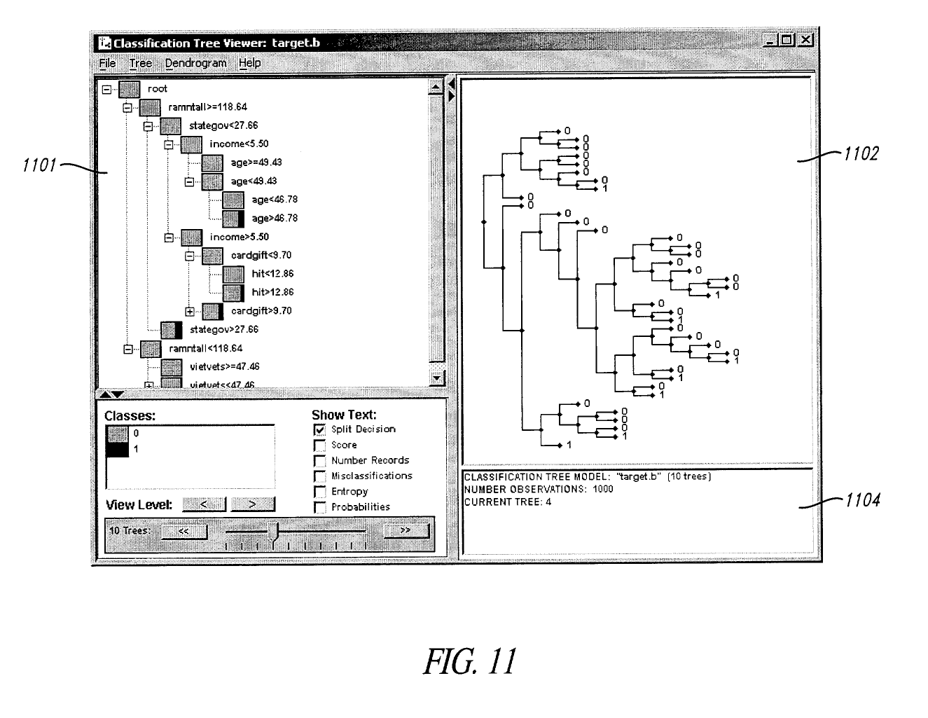

FIG. 11 is an example display screen for viewing a second one of the component predictive models of the generated BMA ensemble model. Model window 1102 shows a classification tree (predictive model) that corresponds to tree number “4” of the 10 trees that comprise the ensemble model of the current example (see information window 1104). As can be seen from the shape of the trees, each tree in FIGS. 10 and 11 is a substantially different shape as might be expected when examining different input data blocks.

Example embodiments described herein provide applications, tools, data structures and other support to implement a Block Model Averaging System to be used for building (train) and deploy statistical models that use block model averaging techniques. One skilled in the art will recognize that other embodiments of the methods and systems of the present invention may be used for other purposes, including for exploratory work. In the following description, numerous specific details are set forth, such as data formats and code sequences, etc., in order to provide a thorough understanding of the techniques of the methods and systems of the present invention. One skilled in the art will recognize, however, that the present invention also can be practiced without some of the specific details described herein, or with other specific details, such as changes with respect to the ordering of the code flow.

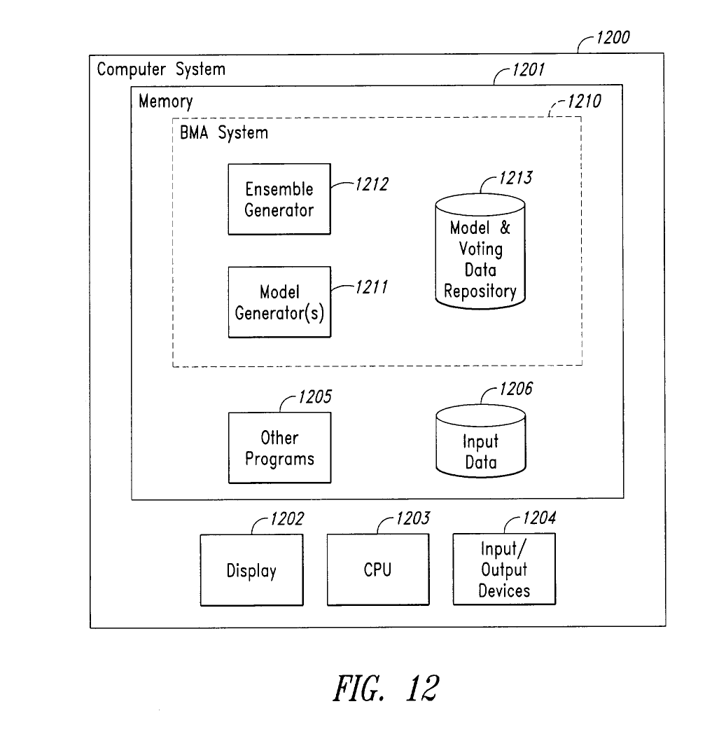

FIG. 12 is an example block diagram of a general purpose computer system for practicing embodiments of a Block Model Averaging System. The general purpose computer system 1200 may comprise one or more server and/or client computing systems and may span distributed locations. In addition, each block shown may represent one or more such blocks as appropriate to a specific embodiment or may be combined with other blocks. Moreover, the various blocks of the Block Model Averaging System 1210 may physically reside on one or more machines, which use standard interprocess communication mechanisms to communicate with each other.

In the embodiment shown, computer system 1200 comprises a computer memory (“memory”) 1201, a display 1202, a Central Processing Unit (“CPU”) 1203, and Input/Output devices 1204. The Block Model Averaging System (“BMAS”) 1210 is shown residing in memory 1201. The components of the Block Model Averaging System 1210 preferably execute on CPU 1203 and manage the generation and use of BMA ensemble models, as described in previous figures. Other downloaded code 1205 and potentially other data repositories, such as input data 1206, also reside in the memory 1210, and preferably execute on one or more CPU's 1203. In a typical embodiment, the BMAS 1210 includes one or more predictive model generators 1211, one or more ensemble model generators 1212, and a Model and Voting Data Repository 1214.

In an example embodiment, components of the BMAS 1210 are implemented using standard programming techniques. One skilled in the art will recognize that the component models, ensemble models, and the model generation tools lend themselves to object-oriented implementations because they are model type based. However, any of the BMAS components 1211-1213 may be implemented using more monolithic programming techniques as well. In addition, programming interfaces to the data stored as part of the BMAS process and to other pipeline components of the data mining system can be available by standard means such as through C, C++, C#, and Java API and through scripting languages such as XML, or through web servers supporting such. The Model and Voting Data Repository 1214 is preferably implemented for scalability reasons as a database system rather than as a text file, however any method for storing such information may be used. In addition, voting protocols and voting population filters may be implemented as stored procedures, or methods attached to ensemble model “objects,” although other techniques are equally effective.

One skilled in the art will recognize that the BMAS 1210 may be implemented in a distributed environment that is comprised of multiple, even heterogeneous, computer systems and networks. For example, in one embodiment, the Predictive Model Generators 1211, the Ensemble Generator 1212, and the Model and Voting data repository 1214 are all located in physically different computer systems. In another embodiment, various components of the BMAS 1210 are hosted each on a separate server machine and may be remotely located from the tables which are stored in the Model and Voting data repository 1214. Different configurations and locations of programs and data are contemplated for use with techniques of the present invention. In example embodiments, these components may execute concurrently and asynchronously; thus the components may communicate using well-known message passing techniques. One skilled in the art will recognize that equivalent synchronous embodiments are also supported by an BMAS implementation. Also, other steps could be implemented for each routine, and in different orders, and in different routines, yet still achieve the functions of the BMAS.

As described in FIGS. 1-11, one of the functions of a BMAS is to build ensemble models that use block model averaging. Also, as mentioned, the BMAS is able to build ensemble models from relatively “static” (snapshots) of data that are presumed to remain stable for some period of time and from dynamic data where the values are presumed to change on some continual time basis. For example, predictive models for static data may be used to predict purchasing decisions for a customer base, based upon a snapshot of the customer base at some particular time; whereas predictive models for dynamic data may be used to project/predict values for data that continues to change on a more rapid basis such as weather conditions, stock prices, body vital signs, etc.

FIG. 13 is an example block diagram of a process for building a BMA ensemble from static data. In FIG. 13, input data 1301 is incrementally read (using preferably a pipeline process) in blocks of data 1311-1314, for example, in blocks of 10,000 rows (records). For each such data block, a predictive model is produced to fit that input data. So, for example, data block 1311 is processed by (the model generator component of) the BMAS to generate Model₁, which is one of the potential component models 1320. Similarly, data block 1312 is processed by the BMAS to generate Model₂, data block 1313 is processed to generate Model₃, and so on. Once the potential component models 1320 are generated (or progressively during the process of building the individual models), the ensemble generator 1330 retrieves the appropriate voting population filter from the Model and Voting Data Repository 1340 to determine (a) the number of component models that were specified as a maximum or as desirable for the ensemble and (b) the filter (procedure) to use to evaluate which potential component models should be included/kept in the ensemble model and which potential component models should be discarded. In addition, the ensemble generator 1330 retrieves an appropriate voting protocol to associate with the ensemble when generated. (Recall that the voting protocol is used when the ensemble is deployed to run on data. It determines how to combine the respective outputs of the component models.) Once the particular components and voting protocol are determined, an ensemble model 1350 is generated and contains indicators of the component models 1351 and of the determined voting protocol 1352. One skilled in the art will recognize that depending upon the particular implementation, actual component models or model objects may be stored or referred to within the ensemble implementation or links to other code may be stored, the ensemble thereby providing an abstraction only, or other combinations may be implemented.

Several techniques may be used as “voting population filters” to evaluate which potential component models should be included/kept in the ensemble model and which potential component models should be discarded, when the number of potential component models exceeds the designated maximum. In the case of classification trees, this number is typically “10” trees. Two of these techniques include retaining the most “correct” models and retaining the most “diverse” set of models. Although discussed herein with respect to building an ensemble model from static data, one skilled in the art will easily recognize that these techniques are as applicable to building and/or adapting an ensemble model to dynamic data.

According to the correctness voting population filter, when the number of potential component predictive models is K+1 (assuming the designated limit is K), the next data block K+2 is read in and predictions from this block of data are obtained using the (individual) K+1 potential component predictive models. A prediction error is calculated for each such model (for example, using misclassification error analysis for classification models and sum-of-square error analysis for regression models). The model that is associated with the highest prediction error is then dropped as a potential component, and the remaining K potential component predictive models are used to build the ensemble model. When applied in an adaptive modeling scenario, prediction errors are calculated for each component model in the current ensemble model and for the newest potential component predictive model and the current ensemble is then modified by replacing the model with the highest prediction error (if currently a component) with the newest potential component predictive model. Otherwise, the newest potential component predictive model is simply discarded.

According to the diversity voting population filter, when the number of potential component predictive models is K+1 (assuming the designated limit is K), the next data block K+2 is read in and predictions from this block of data are obtained to evaluate and to keep a set of “diverse” models. Diverse (good) models are those that contribute to the predictive capabilities of the models already in the ensemble. Techniques known in the art are used to obtain a prediction of diversity measure for each new potential component predictive model to determine whether to replace a least diverse component model with the new potential component predictive model or not. One skilled in the art will recognize that any algorithm used to assess diversity may be incorporated as a voting population filter. Moreover, one skilled in the art will recognize that filters other than for correctness and for diversity may be used with the techniques of the present invention to determine which component models to include in the generated ensemble model.

FIG. 14 is an example block diagram of a process for building a BMA ensemble from dynamic data. The basic mechanism for handling dynamic data is to simply view each incoming data block in the same manner as the BMA process would if the data were static. That is, the next block of data is read and run through the ensemble model. An extension to this basic mechanism, which is extremely useful, especially when the data changes over time, is to adapt the ensemble model itself to the changing data. To perform this adaptation, each time an input data block is read in, the input data block is used in two additional ways: (1) the predictive model generator generates a new potential component predictive model to potentially include in a future modified ensemble model, and (2) the ensemble generator uses the input data block as test data to see if the previously generated new potential predictive model should replace one of the component models in the current ensemble model. Preferably, the current ensemble model is potentially adapted to the previously generated new potential predictive model (based upon the just prior input data block) prior to using the ensemble model to predict on the new input. Said another way, the ensemble model is preferably adapted to any previously generated potential component models prior to predicting output based upon current input data.

More specifically, in FIG. 14, an initial state of a BMA ensemble model 1420 is presumed. Each ensemble model, as explained with reference to prior figures, includes a set of component predictive models and a voting protocol for combining the outputs of the components into a single response output. As with static data, the next block of input data is read in and “observed” by the ensemble model to predict a response output. Thus, for example, new input data blockₓ 1401 is forwarded to ensemble model 1420 to generate response outputₓ. Meanwhile the new input data blockₓ 1401 is also used to generate a new potential predictive modelₓ 1410 which will be evaluated by the ensemble generator using the next input data blockₓ₊₁ 1402 as test data to determine (based upon the appropriate voting population filter from voting data 1440) whether to adapt the ensemble model to replace a current component with the new potential predictive modelₓ 1410. Similarly, the next input data blockₓ₊₁ 1402 is forwarded to ensemble model′ 1421 (potentially adapted as described) to generate response outputₓ₊₁ and to generate another new potential predictive modelₓ₊₁ 1411. The next input data blockₓ₊ₘ 1403 is then used to test the new potential predictive modelₓ₊₁ 1411 to determine a BMA ensemble” 1422, and so on.

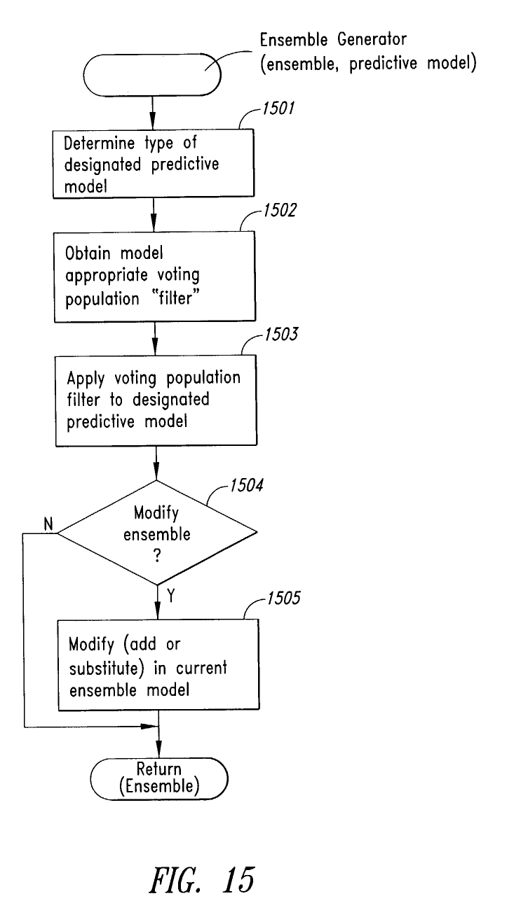

FIG. 15 is an example flow diagram of an example ensemble generation routine provided by an ensemble generator for generating and/or adapting a BMA ensemble model. The routine takes as input a designated ensemble model (which may be null in the case of creating a new one), and a potential component predictive model. The generation routine uses a determined voting population filter, as described earlier, to decide whether to include the designated predictive model in the ensemble or not. Specifically, in step 1501, the generation routine determines the type of model associated with the designated predictive model. In step 1502, the routine determines and retrieves a voting population filter (for example from the Model and Voting data repository) that is appropriate for use with the determined model type. Then, in step 1503, the routine applies the filter to the designated predictive model. In step 1504, if the filter determines that the current ensemble model should be modified to include the designated predictive model, then the routine continues in step 1505, else returns the current ensemble model (unmodified). In step 1505, the routine modifies the current ensemble model, for example by adding the designated predictive model or by replacing a current component model by the designated predictive model, and returns the modified ensemble model as the new current ensemble model.

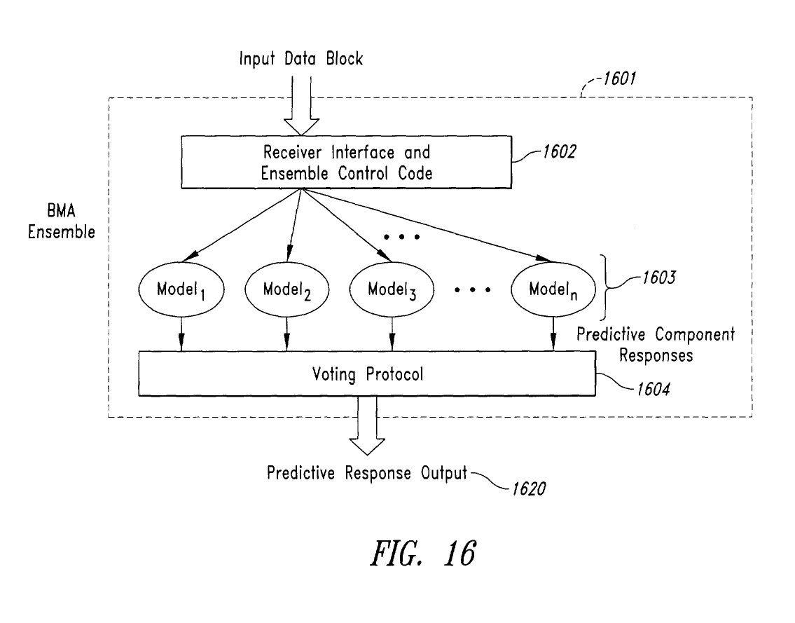

FIG. 16 is an example block diagram of data flow through the components of a BMA ensemble model when deployed to predict a response output. BMA ensemble model 1601 receives a block of input data through a receiver interface and control code module 1602. Once received, the control code 1602 distributes an indication of the input data block to the component predictive models 1603. If the ensemble model is implemented according to the pipeline architecture described with reference to FIG. 3, then the input data block is stored preferably in a buffer that can be read by each of the component models 1603 without needing to actually maintain a copy of the input data. Each component model 1603 then generates a response to each record (row) in the input data. These responses are forwarded to the voting protocol module 1604 of the ensemble model to produce a single predictive response output 1620 for each “observation” (i.e., each record or row).

Different techniques may be used as a voting protocol for an ensemble model. Some techniques differ based upon component model type, some are the same for all. Heterogeneous ensemble models (having component models of mixed model types) may incorporate customized voting protocols. One skilled in the art will recognize that any technique for arbitrating between the answers given by the component predictive models is useable with the BMAS. Three such techniques include: straightforward majority voting, average voting, and weighted average voting.

Straightforward voting implies that the “majority rules.” That is, the prediction (response output) that is output the most is selected as the ensemble prediction. Tie-breaking rules are preferably incorporated for cases where there is no most selected prediction. The tie-breaking rules are typically model type dependent, as classification models lend themselves to a known set of discrete predictions which can be anticipated ahead of time and thus default or priority predictions may be used; whereas regression models, for example, can yield a prediction that is any continuous value so rules that focus on known values will likely not be applicable.

Average voting can be applied to many types of models. In the case of regression models, the predictions of each component are added together and divided by the number of component models. In the case of classification models, weighted average voting, such as averaging based upon the probabilities that a particular classification value will occur appears to yield more accurate ensemble predictions. For example, for a particular level in a classification tree where the predicted value can take on 1 of 3 classification values (“A,” “B,” or “C”) the probabilities that value “A” will occur, value “B” will occur, and value “C” will occur are known. Thus, given a row of input data, each tree can calculate the probabilities that each classification value will occur. For example, the probability (“Pr”) that a classification value will occur across three trees may be as follows:

Pr(“A,” tree1)=0.8, Pr(“B,” tree1)=0.1, Pr(“C,” tree1)=0.1

Pr(“A,” tree2)=0.4, Pr(“B,” tree2)=0.5, Pr(“C,” tree2)=0.1

Pr(“A,” tree3)=0.4, Pr(“B,” tree3)=0.5, Pr(“C,” tree3)=0.1

Tree1 would therefore predict value “A;” tree2 would predict value “B;” and tree3 would predict value “B.” Straightforward voting would yield a single prediction response of value “B” for the ensemble. However, averaging these probabilities across the component trees would yield Pr(“A,” average)=0.533; Pr(“B,” average)=0.367; and Pr(“C,” average)=0.1. Thus, a weighted average based upon probabilities would predict a single prediction response of value “A,” which intuitively appears to give more weight to stronger predictions in the component models. Other weighted voting protocols may also make sense depending upon the type of model being used and the characteristics of the model that are accessible to be measured.

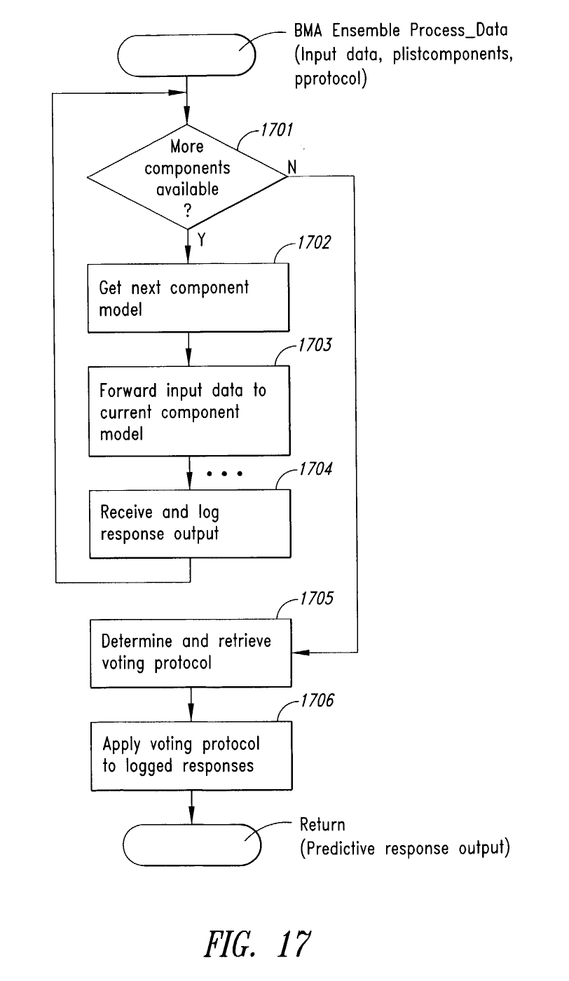

FIG. 17 is an example flow diagram of an example routine provided by a BMA ensemble for processing input data to achieve a predictive response. In some embodiments, a single routine for processing input data can be used regardless of the model type providing certain information is designated, for example, as input parameters to the routine. In one such scenario, a list of component models and a voting protocol are designated parameters. An alternative embodiment would be to create a process data routine for each type of ensemble model that knows how to communicate with the constituent component models. Specifically, in step 1701, the process data routine determines whether any more component models are available to process the input data, and, if so, continues in step 1702, else continues in step 1705. In step 1702, the routine retrieves the next component model (e.g., from the designated list) as the current component model and in step 1703, forwards designated input data to the current component model. In step 1704, the routine receives and stores the prediction from the current component model and returns to the beginning of the loop to handle additional component models in step 1701. In step 1705, the routine determines an appropriate voting protocol, and in step 1706 applies the voting protocol to the predictions from the component models (as described above with respect to FIG. 16), and returns a single predictive response.

All of the above U.S. patents, U.S. patent application publications, U.S. patent applications, foreign patents, foreign patent applications and non-patent publications referred to in this specification and/or listed in the Application Data Sheet, including but not limited to U.S. Provisional Patent Application No. 60/329,827, entitled “Method and System for Image Analysis and Data Mining,” filed Oct. 15, 2001, is incorporated herein by reference, in its entirety.

From the foregoing it will be appreciated that, although specific embodiments of the invention have been described herein for purposes of illustration, various modifications may be made without deviating from the spirit and scope of the invention. For example, one skilled in the art will recognize that the methods and systems for performing pipelined data mining discussed herein are applicable to other architectures other than a pipeline architecture. For example, block model averaging can also be provided for data mining components arranged in a monolithic system. One skilled in the art will also recognize that the methods and systems discussed herein are applicable to differing statistical models, protocols, communication media (optical, wireless, cable, etc.) and devices (such as wireless handsets, electronic organizers, personal digital assistants, portable email machines, game machines, pagers, navigation devices such as GPS receivers, etc.).

1. An automated method in a data mining system for building from an input data set a predictive model for predictive analysis of additional input data, the data set having a sequence of a plurality of blocks of input data, comprising:
for each of the plurality of blocks of input data,
sequentially receiving a next block of data from the input data set; and
creating a predictive model from the received block; and
creating an ensemble model having component models that are determined from the plurality of predictive models, wherein the ensemble model, upon receiving the additional input data, generates a response output that is based upon a combination of the respective outputs of each of component model's processing of the received additional input data.

2. The method of claim 1 wherein the sequential receiving of input data and the creating of the predictive models are performed as part of a pipeline process.

3. The method of claim 2 wherein the pipeline process is performed by data mining components executing in the system.

4. The method of claim 1, further comprising:
upon receiving the additional input data, creating a new predictive model using the additional input data; and
determining whether to integrate the new predictive model into the ensemble model.

5. The method of claim 4, wherein the determining whether to integrate the new predictive model is based upon an assessment of diversity characteristics of the new predictive model relative to the component models.

6. The method of claim 4, further comprising integrating the new predictive model into the ensemble model, thereby adapting the ensemble model to the additional input data.

7. The method of claim 4 wherein the additional input data is a streamed input data.

8. The method of claim 1 wherein the additional input data is a streamed input data.

9. The method of claim 1 wherein the component models are determined by assessing which combination of the predictive models achieves a desired diversity of response to a test input.

10. The method of claim 9 wherein diversity is determined by assessing whether a new model predicts a response when the ensemble model does not.

11. The method of claim 1 wherein the component models are determined by selecting a designated number of predictive models.

12. The method of claim 1 wherein the component models are determined by selecting the predictive models that generate the most correct responses.

13. The method of claim 12 wherein the most correct responses are determined by the least number of miscalculations.

14. The method of claim 1 wherein the ensemble model implements at least one of classification models and regression models.

15. A computer-readable memory medium containing instructions for controlling a computer processor in a data mining system to build from an input data set a predictive model for predictive analysis of additional input data, the data set having a sequence of a plurality of blocks of input data, by:
for each of the plurality of blocks of input data,
sequentially receiving a next block of data from the input data set; and
creating a predictive model from the received block; and
creating an ensemble model having component models that are determined from the plurality of predictive models, wherein the ensemble model, upon receiving the additional input data, generates a response output that is based upon a combination of the respective outputs of each of component model's processing of the received additional input data.

16. The computer-readable memory medium of claim 15 wherein the sequential receiving of input data and the creating of the predictive models are performed as part of a pipeline process.

17. The computer-readable memory medium of claim 16 wherein the pipeline process is performed by data mining components executing in the system.

18. The computer-readable memory medium of claim 15 wherein the instructions further control a computer processor by:
upon receiving the additional input data, creating a new predictive model using the additional input data; and
determining whether to integrate the new predictive model into the ensemble model.

19. The computer-readable memory medium of claim 18 wherein the determining whether to integrate the new predictive model is based upon an assessment of diversity characteristics of the new predictive model relative to the component models.

20. The computer-readable memory medium of claim 18 wherein the instructions further control a computer processor by integrating the new predictive model into the ensemble model, thereby adapting the ensemble model to the additional input data.

21. The computer-readable memory medium of claim 18 wherein the additional input data is a streamed input data.

22. The computer-readable memory medium of claim 15 wherein the additional input data is a streamed input data.

23. The computer-readable memory medium of claim 15 wherein the component models are determined by assessing which combination of the predictive models achieves a desired diversity of response to a test input.

24. The computer-readable memory medium of claim 23 wherein diversity is determined by assessing whether a new model predicts a response when the ensemble model does not.

25. The computer-readable memory medium of claim 15 wherein the component models are determined by selecting a designated number of predictive models.

26. The computer-readable memory medium of claim 15 wherein the component models are determined by selecting the predictive models that generate the most correct responses.

27. The computer-readable memory medium of claim 26 wherein the most correct responses are determined by the least number of miscalculations.

28. The computer-readable memory medium of claim 15 wherein the ensemble model implements at least one of classification models and regression models.

29. A method in a data mining system for producing response output to an input data set using block model averaging, the data mining system having an ensemble model that comprises a plurality of component models generated using block model averaging and a voting protocol, comprising:
under control of the ensemble model,
receiving data from the input data set;
forwarding the received data to each of the component models;
receiving a response from each component model;
using the voting protocol to combine the responses from each of the component models to generate a single predictive response output; and
storing the predictive response output.

30. The method of claim 29 wherein the ensemble model is a predictive modeling component in a system that implements a pipeline architecture.

31. The method of claim 29 wherein the input data set is a stream of data and the received data is a portion of the stream.

32. The method of claim 31 wherein the stream of data is continuous.

33. The method of claim 31 wherein the data stream comprises financial data.

34. The method of claim 31 wherein the data stream comprises weather related data.

35. The method of claim 31 wherein the data stream comprises vital sign measurements.

36. The method of claim 29, further comprising:
generating a predictive model from the received data; and
determining whether to modify the ensemble model to include the predictive model as one of the plurality of component models.

37. The method of claim 36, further comprising modifying the ensemble model to include the generated predictive model.

38. The method of claim 36, further comprising replacing one of the component models with the generated predictive model.

39. The method of claim 36 wherein a voting population filter is used to determine whether to modify the ensemble model.

40. The method of claim 29 wherein the input data is unable to fit in memory at one time.

41. The method of claim 29 wherein the ensemble model implements at least one of classification models and regression models.

42. The method of claim 29 wherein the voting protocol uses a majority voting technique to determine the single predictive response output.

43. The method of claim 29 wherein the voting protocol averages the predictions of each of the component models to determine the single predictive response output.

44. The method of claim 29 wherein the voting protocol uses a weighted average of the predictions of each of the component models to determine the single predictive response output.

45. The method of claim 44 wherein the weighted average averages the probabilities that a particular value will be chosen by a component model.

46. A computer-readable memory medium containing instructions for controlling a computer processor in a data mining system to produce response output to an input data set using block model averaging, the data mining system having an ensemble model that comprises a plurality of component models generated using block model averaging and a voting protocol, by:
under control of the ensemble model,
receiving data from the input data set;
forwarding the received data to each of the component models;
receiving a response from each component model;
using the voting protocol to combine the responses from each of the component models to generate a single predictive response output; and
storing the predictive response output.

47. The computer-readable memory medium of claim 46 wherein the ensemble model is a predictive modeling component in a system that implements a pipeline architecture.

48. The computer-readable memory medium of claim 46 wherein the input data set is a stream of data and the received data is a portion of the stream.

49. The computer-readable memory medium of claim 48 wherein the stream of data is continuous.

50. The computer-readable memory medium of claim 48 wherein the data stream comprises financial data.

51. The computer-readable memory medium of claim 48 wherein the data stream comprises weather related data.

52. The computer-readable memory medium of claim 48 wherein the data stream comprises vital sign measurements.

53. The computer-readable memory medium of claim 46, further comprising:
generating a predictive model from the received data; and
determining whether to modify the ensemble model to include the predictive model as one of the plurality of component models.

54. The computer-readable memory medium of claim 53, further comprising modifying the ensemble model to include the generated predictive model.

55. The computer-readable memory medium of claim 53, further comprising replacing one of the component models with the generated predictive model.

56. The computer-readable memory medium of claim 53 wherein a voting population filter is used to determine whether to modify the ensemble model.

57. The computer-readable memory medium of claim 46 wherein the input data is unable to fit in memory at one time.

58. The computer-readable memory medium of claim 46 wherein the ensemble model implements at least one of classification models and regression models.

59. The computer-readable memory medium of claim 46 wherein the voting protocol uses a majority voting technique to determine the single predictive response output.

60. The computer-readable memory medium of claim 46 wherein the voting protocol averages the predictions of each of the component models to determine the single predictive response output.

61. The computer-readable memory medium of claim 46 wherein the voting protocol uses a weighted average of the predictions of each of the component models to determine the single predictive response output.

62. The computer-readable memory medium of claim 61 wherein the weighted average averages the probabilities that a particular value will be chosen by a component model.

63. A data mining system comprising:
input data set;
ensemble model, comprising a plurality of component models generated using block model averaging and a voting protocol, that is structured to:
receive data from the input data set;
forwards the received data to each of the component models;
receives a response from each component model;
uses the voting protocol to combine the responses from each of the component models to generate a single predictive response output; and
returns the predictive response output.

64. The system of claim 63 wherein the ensemble model is a predictive modeling node in a system that implements a pipeline architecture.

65. The system of claim 63 wherein the input data set is a stream of data and the received data is a portion of the stream.

66. The system of claim 65 wherein the stream of data is continual.

67. The system of claim 65 wherein the data stream comprises financial data.

68. The system of claim 65 wherein the data stream comprises weather related data.

69. The system of claim 65 wherein the data stream comprises vital sign measurements.

70. The system of claim 63, further comprising:
model generator that is structured to generate a predictive model from the received data; and
ensemble generator that is structured to determine whether to modify the ensemble model to include the predictive model as one of the plurality of component models.

71. The system of claim 70 wherein the ensemble generator is further structured to modify the ensemble model to include the generated predictive model.

72. The system of claim 70 wherein the ensemble generator is further structured to replace one of the component models with the generated predictive model.

73. The system of claim 70 wherein a voting population filter is used to determine whether to modify the ensemble model.

74. The system of claim 63 wherein the input data is unable to fit in memory at one time.

75. The system of claim 63 wherein the ensemble model implements at least one of classification models and regression models.

76. The system of claim 63 wherein the voting protocol uses a majority voting technique to determine the single predictive response output.

77. The system of claim 63 wherein the voting protocol averages the predictions of each of the component models to determine the single predictive response output.

78. The system of claim 63 wherein the voting protocol uses a weighted average of the predictions of each of the component models to determine the single predictive response output.

79. The system of claim 78 wherein the weighted average averages the probabilities that a particular value will be chosen by a component model.

80. A data mining system arranged to perform pipeline processing of input data comprising:
a input stream component structured to receive data in a continual fashion;
a plurality of predictive model components, linked as a single unit to the input stream component, such that when input data from the input stream is received, each of the plurality of predictive model components receives an indication of the input data and generates a predictive response; and
a set of voting rules for arbitrating between the predictive responses of the plurality of predictive model components such that a single predictive response output is forwarded to the next component in the pipeline of the data mining system.

81. The data mining system of claim 80 wherein the plurality of predictive model components implement decision trees.

82. The data mining system of claim 81 wherein the decision trees are classification trees.

83. The data mining system of claim 81 wherein the decision trees are regression trees.

84. The data mining system of claim 80 wherein the plurality of predictive model components implement at least one of classification models and regression models.

85. The data mining system of claim 80 wherein the classification models include at least one of classification trees, classification neural networks, logistic regression and Naive Bayes.

86. The data mining system of claim 80 wherein the regression models include at least one of regression trees, regression neural networks, and linear regression.

87. A data mining system arranged to perform pipeline processing of input data comprising:
a input component structured to receive data in a continual fashion; and
a model building component that is linked as a single unit to the input component and that is structured to:
receive a next block of data from the input component, process the received block to generate a predictive model, determine whether to include the generated predictive model as a component model of an ensemble model;
when it is determined to include the generated predictive model in the ensemble model, modify the ensemble model to include the generated predictive model; and
store a representation of the ensemble model.

88. The data mining system of claim 87 wherein the input component receives a continual input stream.

89. The data mining system of claim 87 wherein the input component is linked to a static source of data.

90. The data mining system of claim 87 wherein the ensemble model includes a voting protocol that is used to determine a collective predictive response output from the response outputs of the component models.

91. The data mining system of claim 87 wherein the input data is too large to fit in memory at once.

92. The data mining system of claim 87 wherein to modify the ensemble model, the model building component replaces one component model with the generated predictive model.

93. The data mining system of claim 87 herein the model building component is further structured to test the ensemble model with the received block of data before determining whether to modify the ensemble model to include the predictive model generated from the received block of data.

94. The data mining system of claim 87 wherein the ensemble model implements at least one of classification models and regression models.

95. A block model averaging system comprising:
input receiver that is structured to receive blocks of input data from a data stream;
model generator that is structured to generate a predictive model based upon each block of input data received from the input receiver;
ensemble generator that is structured to choose a voting population of predictive models from the predictive models generated; and
tester that is structured to test the effectiveness of a generated predictive model using a next block of input data.
